(19) United States
(12) Patent Application Publication
(10) Pub. No.: US 2006/0154526 A1
(43) Pub. Date: Jul. 13, 2006

(54) Printed circuit board and electronic apparatus equipped with the same

(75) Inventor: Yasuhito Uetsuki, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/324,240

(22) Filed: Jan. 4, 2006

(30) Foreign Application Priority Data
Jan. 7, 2005 (JP) 2005-002360

(51) Int. Cl. H01R 13/648

(52) U.S. Cl. 439/607

(57) ABSTRACT

A printed circuit board is adjacently mounted on a part of a chassis substantially in parallel with each other and the chassis serves as an all-overlaying GND pattern layer. Furthermore, by placing an insulator between the printed circuit board and the chassis, the stray capacitance around signal lines D+ and D− is stabilized in a proper range. Thus, a differential impedance between the USB signal lines D+ and D− is made in compliance with standard concerned. As a result, in an electronic device equipped with an interface in conformity to the USB 2.0 standard, the differential impedance can be made in compliance with the standard in spite of using an inexpensive two-layered board.

### BACKGROUND OF THE INVENTION

1. Field of the Invention

The present invention relates to a printed circuit board used for an image forming device and the like and an electronic apparatus equipped with the printed circuit board.

2. Description of the Related Art

In a conventional high frequency circuit described in, for example, Japanese Laid-Open Patent Publication No. 11-205012, a dielectric layer comprised of a dielectric substrate and a dielectric adhesive is used as a path for the propagation of an electromagnetic field, and a chassis is also used as a contact face of a high frequency circuit.

In another conventional printed circuit board described in Japanese Laid-Open Patent Publication No. 8-335784, a signal layer is separated into a TTL (Transistor-Transistor Logic) signal wiring area and a ground layer, and an area of the ground layer is arranged between a power source layer and a GTL (Gunning Transceiver Logic) signal wiring area to reduce a number of layers of a multilayered circuit board.

In still another conventional high frequency circuit board described in Japanese Laid-Open Patent Publication No. 2001-144386, by making a land pattern formed at both ends of the printed circuit board asymmetrical, adjoining lands may not be connected to each other even when soldering is performed in the case where a plurality of printed circuit boards are put together.

In electronic devices such as an image forming device, USB (Universal Serial Bus) 2.0 has widely spread as a simple and high-speed interface. In this USB 2.0, although a differential signal is transmitted using USB signal lines D+ and D−, the standard provides that a differential impedance of 90 Ω may be ensured to achieve 480 Mbps. In the conventional printed circuit board, by forming an all-overlaying GND (Ground) pattern layer which covers almost whole region of the board adjacent to a USB signal pattern layer on which the USB signal lines D+ and D− are formed, a stray capacitance between both layers is stabilized in a proper scope to ensure the above-mentioned differential impedance. However, in order to provide such an all-overlaying GND pattern layer adjacent to the USB signal pattern layer, an expensive printed circuit board of three or more layers is inevitably needed, causing substantial rise in the manufacturing cost of the electronic device.

Furthermore, in the above-mentioned conventional printed circuit boards, although the all-overlaying GND pattern is mentioned, any of the printed circuit boards does not assume the use in the interface of the USB 2.0 standard and problems characteristic of the USB 2.0 standard are not considered. Thus, the problem of ensuring the above-mentioned differential impedance cannot be addressed.

### SUMMARY OF THE INVENTION

To solve the above-mentioned problems, the present invention intends to provide a printed circuit board capable of meeting the USB 2.0 standard in spite of using an inexpensive two-layered board and an electronic device equipped with the printed circuit board.

A printed circuit board in accordance with the present invention has an electronic component is installed and signal lines are formed thereon. A metal plate or a metal film is disposed adjacent to and in parallel with the printed circuit board and the metal plate or the metal film serves as an all-overlaying GND pattern layer which covers almost whole region of the board.

With such configuration, since the metal plate or the metal film serves as the all-overlaying GND pattern layer, even when the printed circuit board is not arranged to face a chassis formed of a metal plate, the stray capacitance of the printed circuit board can be stabilized within a proper range without providing the all-overlaying GND pattern layer in the printed circuit board. As a result, it is possible to make differential impedance between two signal lines formed on the printed circuit board proper.

According to the above-mentioned printed circuit board, it is preferable that an insulator is placed between the metal plate or the metal film and the board.

By placing the insulator with a distinct dielectric constant between the metal plate or the metal film and the board in this manner, the stray capacitance between the signal lines and the metal plate or the metal film can be freely adjusted and the differential impedance between the signal lines can be made proper more easily.

On the other hand, another printed circuit board in accordance with the present invention has a USB terminal in compliance with USB 2.0 standard installed thereon and is mounted on a chassis formed of a metal plate of an image forming device. The printed circuit board comprises a first layer on which at least USB signal lines are formed and a second layer on which at least a power line is formed. By adjacently mounting the printed circuit board on the chassis substantially in parallel with each other and placing an insulator between the chassis and the printed circuit board, the stray capacitance between the first layer and the chassis is made proper, and by allowing the chassis to serve as an all-overlaying GND pattern layer which covers almost whole region of the board, the differential impedance between the USB signal lines is made in compliance with the USB 2.0 standard without providing the all-overlaying GND pattern layer in the printed circuit board and the USB 2.0 standard can be met in spite of using the two-layered board.

With such configuration, since the chassis arranged to face the printed circuit board substantially in parallel with each other serves as the all-overlaying GND pattern, the stray capacitance between the USB signal lines of the first layer and the chassis can be stabilized within a proper range without providing the all-overlaying GND pattern in the printed circuit board. As a result, even when an inexpensive two-layered board, the differential impedance between the USB signal lines can meet the USB 2.0 standard. By placing the insulator having a distinct dielectric constant between the printed circuit board and the chassis, the stray capacitance between the USB signal lines on the first layer and the chassis can be freely adjusted and the differential impedance between USB signal lines can be easily made in compliance with the standard.

The electronic device in accordance with the present invention is equipped with either of the above-mentioned printed circuit boards. Thus, since the all-overlaying GND pattern layer need not be provided in the printed circuit board forming the electronic device, a number of lamination layers of the printed circuit board can be reduced, thereby achieving reduction in costs.

### BRIEF DESCRIPTION OF THE DRAWINGS

FIG. 1 is a block diagram showing a configuration of an image forming device in accordance with an embodiment of the present invention;

FIG. 2 is a perspective view showing a configuration of an image data input circuit of the image forming device;

FIG. 3 is a side view showing a configuration of the image data input circuit including a chassis; and

FIG. 4 is a side view showing a configuration of the image data input circuit in which a metal plate is used in place of the chassis.

### DETAILED DESCRIPTION OF THE EMBODIMENT

An image forming apparatus in accordance with an embodiment of the present invention is described with reference to the figures.

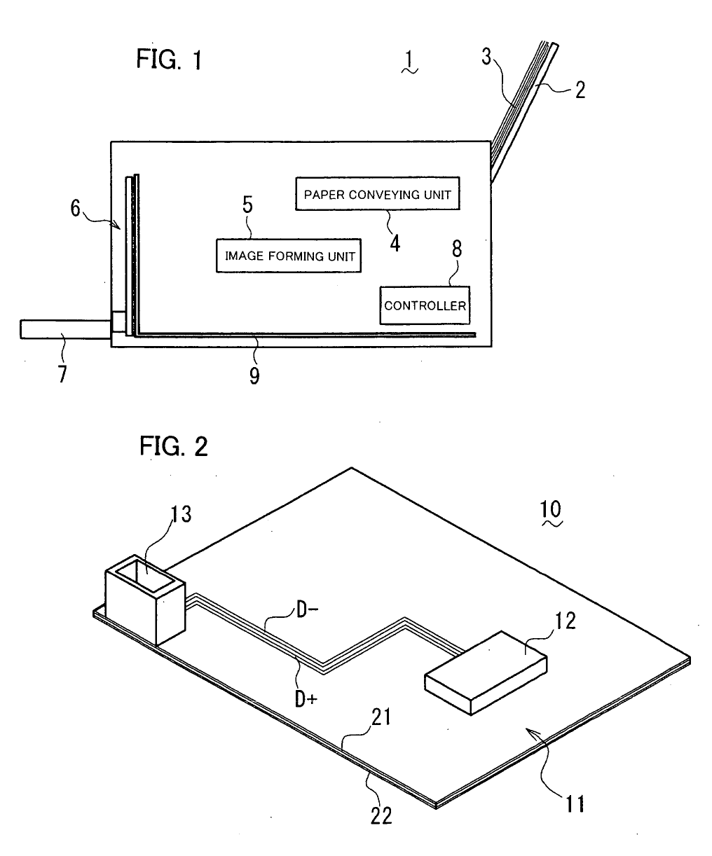

FIG. 1 shows a block configuration of the image forming device 1. The image forming device 1 has a recording paper conveying unit 4 for conveying a recording paper sheet 3 loaded on a paper feeding tray 2 into the image forming device 1 and also conveying the recording paper sheet 3 on which an image is formed by an image forming unit 5 to a paper output tray 7. The image forming unit 5 forms an image on the recording paper sheet 3 conveyed by the recording paper conveying unit 4. An image data input unit 6 inputs data of an image which is to be formed on the recording paper 3 by the image forming unit 5. A control unit 8 controls the recording paper conveying unit 4, the image forming unit 5 and the image data input unit 6. A chassis 9 made of a metal plate supports each of these units. The image data input part 6 is configured in compliance with the USB 2.0 standard so that image data can be easily transmitted from a digital camera, a personal computer or the like at high speed.

FIG. 2 shows an image data input circuit 10 forming the image data input part 6. The image data input circuit 10 is configured by mounting various electronic components on a printed circuit board 11 on which a wiring pattern is formed. In this embodiment, to reduce the cost of the image forming device 1, the two-layered printed circuit board 11 is used. In FIG. 2, USB signal lines D+ and D− are provided on a first layer 21 formed on an upper surface of the printed circuit board 11 and a power line (not shown), through which an electric power is supplied to the image data input circuit 10 and a digital camera, is provided on a lower surface of the printed circuit board 11.

An IC chip 12 for controlling the printed circuit board 11 and a USB terminal 13 to be connected to a USB cable for receiving image data from the digital camera and the like are installed on the first layer 21 of the printed circuit board 11. The IC chip 12 and the USB terminal 13 are connected to each other via the USB signal lines D+ and D− so that various data such as image data is transmitted by a differential signal between the USB signal line D+ and the USB signal line D−.

In order to acquire a proper differential signal between the USB signal line D+ and the USB signal line D−, a differential impedance between the signal line D+ and the signal line D− is defined as 90 Ω in the USB 2.0 standard, as mentioned above. Thus, it is necessary to make stray capacitance around the signal line D+ and the signal line D− proper. In a printed circuit board normally designed, an all-overlaying GND pattern layer (i.e. second layer) is formed adjacent to the first layer on which the USB signal lines are formed. However, when such a configuration of layers is employed, a number of lamination layers of the printed circuit board increases, and thereby the cost of the board cannot be reduced. Then, in this embodiment, the printed circuit board 11 is adjacently mounted on a part of the chassis 9 substantially in parallel with each other and the chassis 9 is made to serve as an all-overlaying GND pattern layer so that the all-overlaying GND pattern layer can be omitted from the printed circuit board 11.

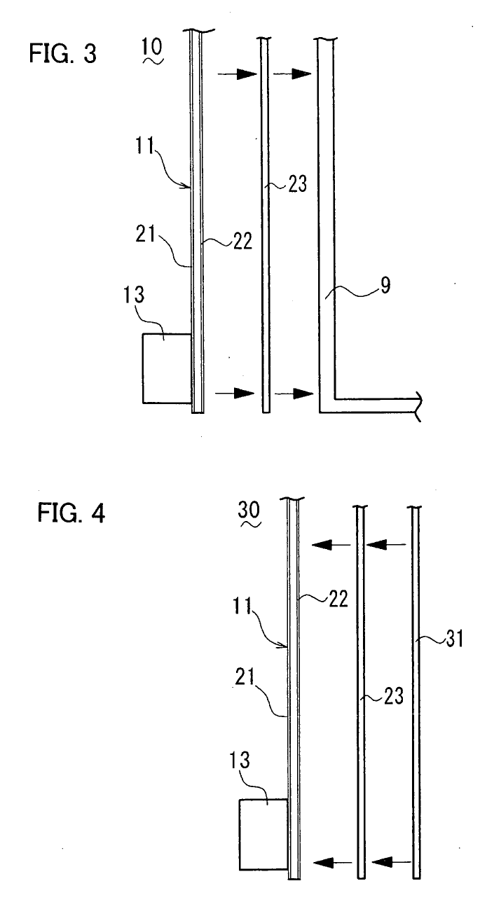

FIG. 3 shows a configuration of the image data input circuit 10 including the chassis 9. The printed circuit board 11 is attached to the chassis 9 via an insulator 23. In this embodiment, since the USB signal lines D+ and D− are formed on a component mounting surface on the opposite side to the chassis 9, a distance between these lines and the all-overlaying GND pattern (that is, chassis 9) is increased up to about 1.6 mm, and the stray capacitance around the signal lines D+ and D− is decreased. Then, the stray capacitance is made proper by placing the insulator 23 having an appropriate dielectric constant between the printed circuit board 11 and the chassis 9.

FIG. 4 shows another configuration of an image data input circuit 30 in which a metal plate 31 serves as the all-overlaying GND pattern layer instead of the chassis 9. This configuration is effective in a case that the printed circuit board 11 cannot be disposed to face a part of the chassis 9 in terms of layout design of the image forming device 1. In the image data input circuit 30, the insulator 23 is placed between the printed circuit board 11 and the metal plate 31. A metal film may be used instead of the metal plate 31.

As described above, according to the image forming device 1 in this embodiment, since the chassis 9 or the metal plate 31 facing to and substantially in parallel with the printed circuit board 11 serves as the all-overlaying GND pattern layer, the stray capacitance around the USB signal lines D+ and D−, that is, between the first layer of the printed circuit board 11 and the chassis 9 or the metal plate 31 can be stabilized within a proper range without providing the all-overlaying GND pattern layer in the printed circuit board. As a result, even when an inexpensive two-layered board is used, the differential impedance between the USB signal lines D+ and D− can be made in compliance with the USB 2.0 standard. Furthermore, by placing the insulator 23 having a distinct dielectric constant between printed circuit board 11 and the chassis 9 or the metal plate 31, the stray capacitance around the USB signal lines D+ and D− can be freely adjusted and the differential impedance between the USB signal lines D+ and D− can be easily made compliant with the USB 2.0 standard.

The present invention is not limited to the above-mentioned configuration, and it is sufficient to be configured that the chassis 9 or the metal plate 31 is arranged adjacent to and substantially in parallel with the USB signal lines D+ and D− so as to serve as the all-overlaying GND pattern layer. Furthermore, the present invention can be modified in various manners. For example, the USB signal lines D+ and D− may be provided on a surface opposed to the chassis 9 or the metal plate 31. In such a case, since the distance between the USB signal lines D+ and D− and the chassis 9 or the metal plate 31 can be made smaller, the insulator 23 can be omitted, thereby achieving further reduction in costs.

This application is based on Japanese patent application 2005-2360 filed Jan. 7, 2005 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A printed circuit board on which an electronic component is installed and signal lines are formed, wherein
a metal plate or a metal film is disposed adjacent to and substantially in parallel with the printed circuit board; and
the metal plate or the metal film serves as an all-overlaying GND pattern layer which covers almost whole region of the board.

2. The printed circuit board in accordance with claim 1, wherein
an insulator is placed between the metal plate or the metal film and the board.

3. A printed circuit board, on which a USB terminal in compliance with USB 2.0 standard is installed and which is mounted on a chassis formed of a metal plate of an image forming device, wherein
the printed circuit board comprises a first layer on which at least USB signal lines are formed and a second layer on which at least a power line is formed;
the printed circuit board is adjacently mounted on the chassis substantially in parallel with each other;
an insulator is placed between the chassis and the board so that a stray capacitance between the first layer and the chassis is made reasonable;
by allowing the chassis to serve as an all-overlaying GND pattern layer which covers almost whole region of the board, a differential impedance between the USB signal lines is made in compliance with the USB 2.0 standard without providing the all-overlaying GND pattern layer in the printed circuit board so that the USB 2.0 standard can be met in spite of using a two-layered board.

4. An electronic apparatus equipped with a printed circuit board on which an electronic component is installed and signal lines are formed, wherein
a metal plate or a metal film is disposed adjacent to and substantially in parallel with the printed circuit board and serves as an all-overlaying GND pattern layer which covers almost whole region of the board.

5. The electronic apparatus in accordance with claim 4, wherein
an insulator is placed between the metal plate or the metal film and the board.

6. The electronic apparatus in accordance with claim 4, wherein
the electronic component is a USB terminal in compliance with USB 2.0 standard.

7. The electronic apparatus in accordance with claim 6, wherein
the printed circuit board is a two-layered board comprised of a first layer on which at least USB signal lines are formed and a second layer on which at least a power line is formed.
